(19) United States
(12) Patent Application Publication
(10) Pub. No.: US 2016/0133199 A1
(43) Pub. Date: May 12, 2016

(54) DISPLAY BRIGHTNESS CONTROL

(71) Applicant: Sony Corporation, Tokyo (JP)

(72) Inventors: Jungle Chu, Taipei (TW); Oj Ou, Taipei (TW)

(21) Appl. No.: 14/537,444

(22) Filed: Nov. 10, 2014

(51) Int. Cl. G09G 3/34

(52) U.S. Cl. CPC G09G 3/3413; G09G 2320/0626

(57) ABSTRACT

A display brightness is selected depending on a distribution of brightness values of pixels of image data received from a camera. A display is controlled to display the image data or further image data employing the selected display brightness.

### FIELD OF THE INVENTION

Various embodiments relate to a user equipment and to a method. In particular, various embodiments relate to techniques of selecting a display brightness of a display of the user equipment, said selecting depending on a distribution of brightness values of at least some pixels of image data received from a camera of the user equipment.

### BACKGROUND OF THE INVENTION

Electronic user equipment (UE) is often provided with a display. The display is typically controlled to display image data employing a certain display brightness. For this, it is possible that the UE comprises background illumination of variable strength and/or employs other techniques to variably set the illumination strength of the display. On the one hand, a high display brightness may be desirable to ensure perceptibility of the image data displayed on the display; user experience is enhanced. On the other hand, a high display brightness typically results in high energy consumption, e.g., for background lighting, etc.

UEs are known which are equipped with an ambient light sensor. Typically, the ambient light sensor is implemented as a photo diode and is configured to sense an ambient brightness in the surrounding of the UE. A processor of the UE can then select a display brightness depending on the sensed ambient brightness. Typically, if there is a low (high) ambient brightness, the processor is configured to select a low (high) display brightness.

However, such techniques face certain restrictions. E.g., the ambient light sensor is typically positioned on a top surface of the UE. Thus, the field of view of the ambient light sensor may be restricted towards one side of the UE. As a result, the ambient light sensor may have limited accuracy in the determining of the ambient brightness. Situations of limited perceptibility of content displayed on the display may result. Providing a plurality of ambient light sensors orientated in different directions and having different fields of view may cause higher space requirements and increase the overall costs of the UE.

### BRIEF SUMMARY OF THE INVENTION

Therefore, a need exists to provide advanced techniques of controlling the display brightness. In particular, a need exists to provide such techniques which enable to flexibly select the display brightness according to a user's needs. In particular, a need exists to provide such techniques which select the display brightness such that good perceptibility of image data displayed on the display of the UE is maintained.

According to various embodiments, a UE is provided. The UE comprises a camera and at least one processor. The at least one processor is configured to receive image data from the camera. The image data comprises pixels. The image data indicates brightness values for the pixels. The at least one processor is further configured to select a display brightness depending on a distribution of the brightness values of at least some of the pixels. The at least one processor is further configured to control a display of the UE to display at least one of the image data and further image data employing the selected display brightness.

According to various embodiments, a method is provided. The method comprises the step of at least one processor receiving image data from a camera of a UE. The image data comprises pixels. The image data indicates brightness values for the pixels. The method further comprises the step of the at least one processor selecting a display brightness depending on a distribution of the brightness values of at least some of the pixels. The method further comprises the step of the at least one processor controlling a display of the UE to display at least one of the image data and further image data employing the selected display brightness.

### BRIEF DESCRIPTION OF THE DRAWINGS

Embodiments of the invention will be described with reference to the accompanying drawings in which the same or similar reference numerals designate the same or similar elements.

FIG. 1 is a schematic illustration of image data comprising pixels and indicating brightness values for the pixels according to various embodiments.

FIG. 2 is a schematic contour plot of the brightness values of the image data according to various embodiments, wherein in FIG. 2 a vivid light scenario is illustrated.

FIG. 3 illustrates a distribution of the brightness values according to various embodiments.

FIG. 4 is a schematic illustration of average brightness values determined for associated image regions according to various embodiments.

FIG. 5 is a schematic illustration of a UE according to various embodiments.

FIG. 6 is a flowchart of a method according to various embodiments.

FIG. 7 is a flowchart of a method according to various embodiments.

### DESCRIPTION OF EMBODIMENTS

Exemplary embodiments of the invention will be described with reference to the drawings. While some embodiments will be described in the context of specific fields of application, e.g. in the context of certain spectral ranges and communication techniques, the embodiments are not limited to this field of application. The features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof

Hereinafter, techniques of selecting a display brightness which is employed for displaying image data on a display of a UE are discussed. In general, the UE may be any device having a camera. The UE may further have a display for previewing a photo to be acquired. E.g., the UE may be a digital camera or an event data recorder. E.g., the UE may be a mobile device of a group comprising a mobile phone, a smartphone, a personal digital assistant, a mobile music player, a smart watch, a wearable electronic equipment, and a mobile computer. The display brightness is selected based on a distribution of brightness values of at least some pixels of image data which is received from a camera.

Such techniques enable to select the display brightness in a manner that ensures a sufficient perceptibility of content displayed on the display. In particular, the sufficient perceptibility may be ensured in scenarios where the camera of the UE is used to acquire image data and a preview of the image data is provided on the display of the UE. Here, even in scenarios referred to as vivid light scenario hereinafter where one or more comparably bright light spots are situated within a comparably dark background in the field of view of the camera, the sufficient perceptibility may be preserved.

E.g., considering the UE being a smartphone having a camera for acquisition of photos, this is illustrated in the following example in detail. It is possible that in the process of taking the photo, image data is continuously acquired and displayed on the display to provide a preview image of the photo to be acquired. The scenery which is within the field of view of the camera and therefore imaged by the image data may contain a vivid light source, e.g., the setting sun during sunset or a neon sign during the night, against a dark background. Reference implementations are known which rely on an ambient light sensor which senses an ambient brightness. Based on the sensed ambient brightness, the display brightness is selected. According to such reference implementations relying on an ambient light sensor, it is possible that the overall low ambient brightness caused by the dark background leads to a low display brightness being selected. Then, it becomes difficult to perceive the content displayed on the display and a low perceptibility results; sometimes, only the vivid light source may be visible on the display. According to various embodiments, a higher display brightness may be selected; this is because the distribution of the brightness values of the pixels of the image data typically shows a high spread between the brightness values of the various pixels in the above-mentioned scenarios corresponding to the vivid light source and the dark background. The distribution has a comparably large width. E.g., a difference in the brightness values between pixels imaging the vivid light source and pixels imaging the dark background may be comparably large; this may be the decision criterion to select a maximum display brightness.

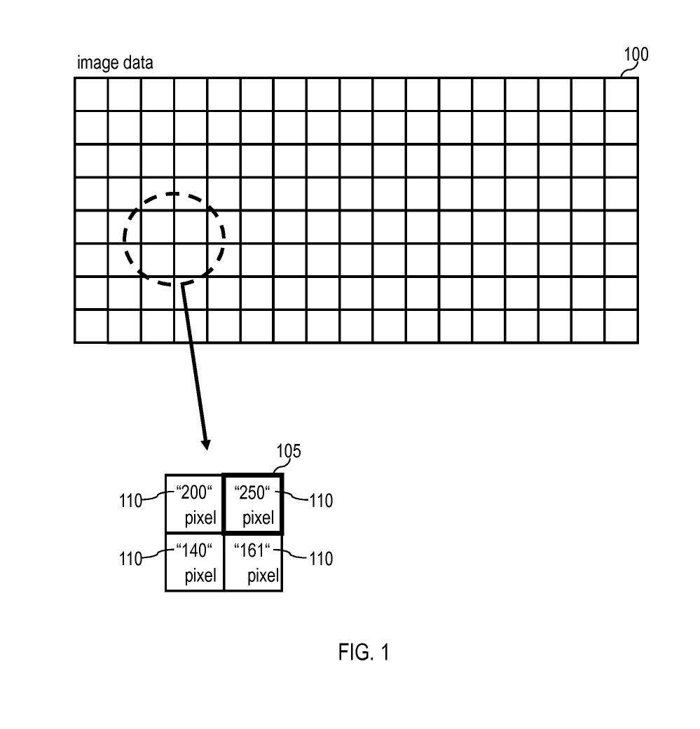

Such techniques are described in detail hereinafter. First, making reference to FIG. 1, image data 100 is illustrated. The image data 100 comprises a number of pixels 105 (in FIG. 1, the part encircled in the upper part using a dashed line is illustrated in detail in the lower part; here, one of the pixels 105 is exemplarily highlighted using a thicker line). In FIG. 1, each one of the pixels 105 specifies a corresponding brightness value 110 (shown in FIG. 1 using arbitrary units). Each one of the pixels 105 may further specify a color (not shown in FIG. 1). In general, various encoding schemes for specifying the color and brightness value are known, e.g., the RGB-scheme and YUV-scheme; it is possible, that the brightness value is indirectly or implicitly specified.

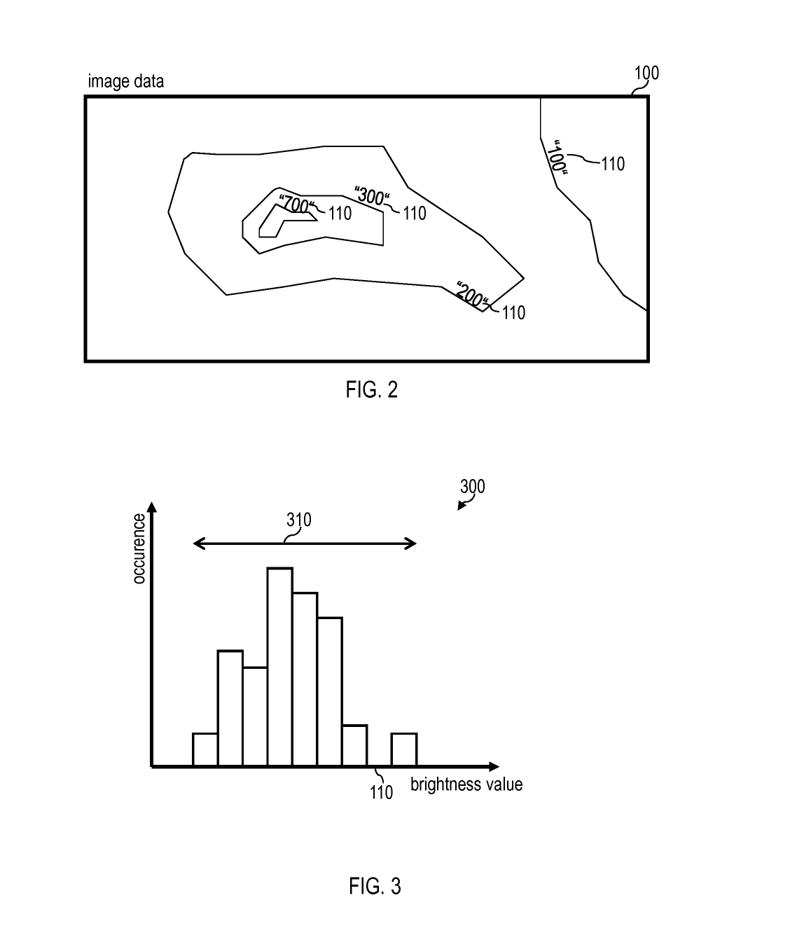

In FIG. 2, a contour plot of the brightness values 110 for the image data 100 for a scenery that includes a vivid light spot against a comparably dark background (vivid light scenario) is shown. As can bee seen, in the inner part of the image data 110, there are pixels 105 (not shown in FIG. 2) that have a brightness value 110 amounting to “700” (arbitrary units)—while in other parts of the image data 110, there are pixels 105 (not shown in FIG. 2) that have a brightness value 110 amounting to “100” (arbitrary units). In other words, a difference between the brightness values 110 is comparably high in the image data 100 in the scenario of FIG. 2. For illustrative purposes it is noted that the scenery of FIG. 2 could be, e.g., a sunset or a neon light against dark background.

Making reference to FIG. 3, a distribution 300 of the brightness values 110 is shown. The difference 310 of the brightness values 110 is a specific property of the distribution 300 of the brightness values 110 as it specifies the width of the distribution 300. In FIG. 3, a full width of the distribution 300 is illustrated (shown by the horizontal arrow in FIG. 3) as the difference 310. As can be seen, the distribution 300 of the brightness values 110 is specified by differences of brightness values of pairs of the pixels 105. Other parameters that specify the distribution 300 could be, e.g., a characteristic width of the distribution 300 such as a full width at half maximum or the full width, an asymmetry of the distribution 300, a maximum value of the distribution 300 in absolute units, etc. The distribution 300, i.e., all such parameters of the distribution 300 as mentioned above, may be taken into account when selecting the display brightness. It is possible to take into account a specific one of such parameters or a combination of such parameters when selecting the display brightness.

Generally, the qualitative dependency of the display brightness on the distribution 300 may vary. In a scenario, a first display brightness is selected if the distribution 300 indicates that the difference 310 of the brightness values 110 of the pixels 105 exceeds a predefined threshold; a second display brightness is selected if the distribution 300 indicates that the difference 310 of the brightness values 110 of the pixels 105 does not exceed the predefined threshold. The first display brightness is higher than the second display brightness. For such a qualitative dependency, in a vivid light scenario (cf. FIG. 2)—where the distribution 300 has a comparably high width—perceptibility of the image data 100 on the display of the UE may be ensured; at the same time, when for a scenery which is not specified by a high spread of brightness values, it is possible to select the lower display brightness to reduce energy consumption.

Further, a quantitative dependency of the display brightness on the distribution 300 may vary. E.g., when selecting an absolute value for the display brightness, it is possible to take into account an ambient brightness. E.g., the UE may comprise an ambient light sensor, which may provide control data indicating the ambient brightness. It is possible that a candidate display brightness is selected based on the control data. In particular, the candidate display brightness may be selected depending on the ambient brightness indicated by the control data. It is then possible to selectively select the candidate display brightness as the display brightness depending on the distribution 300 of the brightness values 110 of the pixels 105. E.g., if a characteristic width of the distribution 300 is comparably small, it is possible that the candidate display brightness is selected as the display brightness. However, if the distribution 200 indicates a vivid light environment, i.e., the characteristic width of the distribution 300 is comparably large, it is possible that the candidate display brightness is not selected as the display brightness; here, it is possible that a maximum display brightness is selected as the display brightness. E.g., the maximum display brightness may correspond to a maximum value of the display brightness which can be achieved given technical specifications and capabilities of the UE, in particular of the display.

As can be seen from the above, both, the qualitative as well as the quantitative dependencies of the selected display brightness on the distribution 300 of the brightness values 110 of the pixels 105 is not particularly limited.

In general, it is possible that the distribution 300 of the brightness values 110 takes into account all of the pixels 105 of the image data 100. It is also possible that only some of the pixels 105 are considered when selecting the display brightness; i.e., the distribution 300 may take into account only some of the pixels 105. E.g., in such a scenario only those pixels 105 which are situated within a center region or in a border region of the image data 100 may be taken into account.

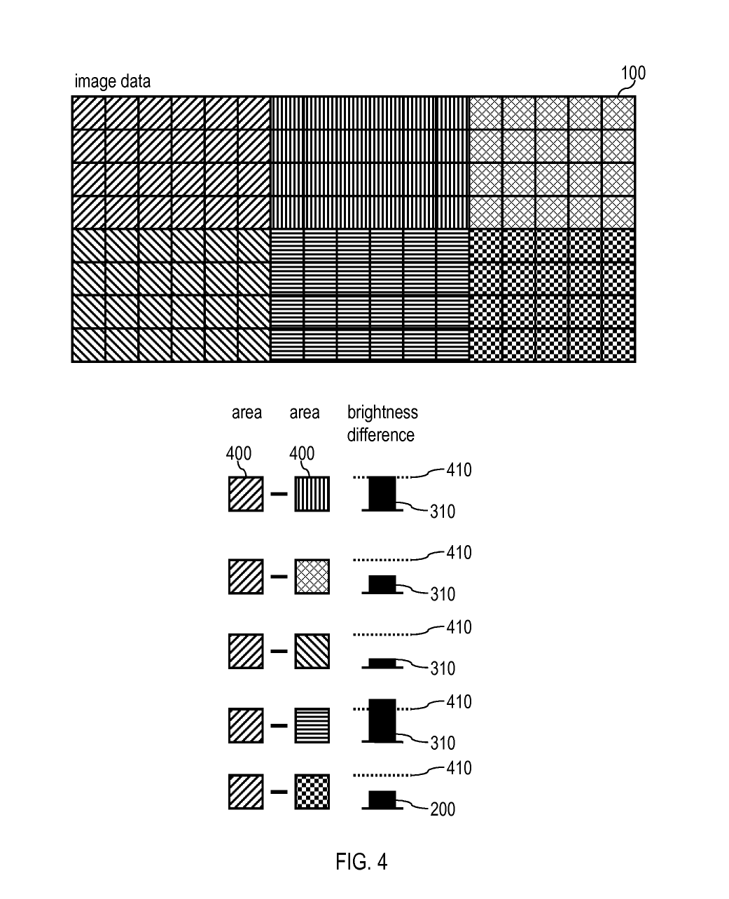

Further, according to embodiments it is also possible to consider the brightness values 110 of the pixels 105 or some of the pixels 105 in an indirect manner. Making reference to FIG. 4, is possible that average brightness values are determined for zones or image regions 400 of the image data 100 (in FIG. 4, the various image regions 400 are shown with different filling patterns). Then, the distribution 300 may take into account the average brightness values; also in such a scenario, it is possible to consider a characteristic width of the respective distribution 300 as a decision criterion for selecting the display brightness. E.g., the maximum width of the distribution 300 may be considered.

Such an exemplary scenario is illustrated with respect to FIG. 4 in greater detail. As can be seen from FIG. 4, lower part, the distribution 300 of the brightness values 110 is specified by differences of the average brightness values of pairs of associated image regions 400 of the image data 110. In the scenario FIG. 4, the average brightness values are averages over the brightness values 110 of those pixels 105 which are situated in the respective image region 400. E.g., the difference 310 of the average brightness values of the image reasons 400 labelled with the diagonally dashed filling pattern and the vertically dashed filling pattern is shown in the first row, lower part of FIG. 4.

A threshold comparison is executed between each one of the differences 310 on the average brightness values and a predefined difference threshold 410 (shown in FIG. 4 with the dotted line). The display brightness is selected depending on the threshold comparison. As can be seen from FIG. 4, in the illustrated scenario all but one difference 310 do not exceed the predefined difference threshold 410. Thus, the full width of the corresponding distribution 300 (not shown in FIG. 4) exceeds the predefined difference threshold 410. Because of at least one of the differences 310 of the average brightness values exceeding the predefined difference threshold 410, the maximum display brightness is selected.

Generally, it is possible that the display brightness is uniformly adjusted, i.e., one and the same display brightness is selected for each one of the pixels 105. However, it is also possible that the display brightness is selected in a pixel-dependent manner; i.e., it is possible that a different display brightness is selected for different pixels 105. E.g., a higher (lower) display brightness can be selected for those pixels 105 which are situated in an image region 400 which has a lower (higher) average brightness value. I.e., the display brightness is spatially dependent. In such a manner, clipping of the brightness values may be avoided.

In the above-mentioned scenario, the image data 110 is received from the camera of the UE and the brightness values 110 of the various pixels 105 are analyzed for previewing of the image data on the display. Here, six image regions 400 are considered and the difference 310 of the average brightness values is determined for each pair of the image regions 400. The predefined brightness threshold 410 can be adjusted during the development stage. Each one of the differences 310 may be stored in a memory of the UE and compared to the predefined brightness threshold 310. If any one of the differences 310 exceeds the predefined brightness threshold 410, it is judged that the vivid light scenario is present. Then, the maximum display brightness is selected as the maximum that the display of the UE supports. Otherwise, an original setting of the display brightness may be used, e.g., determined based on the control data from the ambient light sensor. Such features as mentioned above may be implemented by software only, by hardware only, or a combination thereof. Software implementation may be desired to reduce complexity and costs.

E.g., the UE may comprise a user interface or human machine interface (HMI). It is possible that the selecting of the display brightness depending on the distribution 300 of the brightness values 110 of the pixels 105 is selectively executed based on control data received from the HMI, the control data indicating a user input.

Further, it is possible that a threshold comparison is executed between the ambient brightness indicated by the control data received from the ambient light sensor and the predefined brightness threshold. It is then possible to selectively execute said controlling or display to display the image data 110 employing the selected display brightness depending on the threshold comparison. Likewise, it is possible to selectively execute said selecting of the display brightness depending on the distribution 300 of the brightness values 110 of the pixels 105 depending on a threshold comparison. E.g., if the ambient brightness falls below the predefined brightness threshold 410, it can be desired to avoid selecting of the display brightness depending on the distribution 300 of the brightness values 110 of the pixels 105. I.e., the predefined brightness threshold 410 can be set during a developing stage. E.g., the predefined brightness threshold can amount to 20 lux. Thereby, the user experience can be increased.

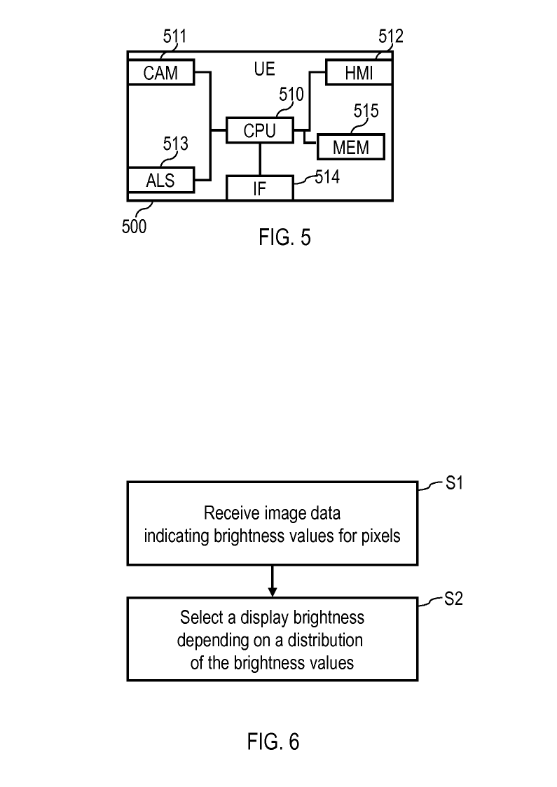

In FIG. 5, the UE 500 is schematically illustrated. The UE 500 comprises a processor 510; e.g., the processor 510 can be implemented as a single-core processor or a multi-core processor. Shared computing may be relied upon. It is also possible that some of the computational tasks of the processor 510 are delegated to a further processor of a different entity (not shown in FIG. 5).

Further, the UE 500 comprises a memory 515, e.g., a non-volatile memory or a volatile memory. The memory 515 stores control instructions that, when executed by the processor 510, cause the processor to execute steps according to the techniques as mentioned above. In particular, the control instructions stored in the memory 515 can relate to techniques of selecting the display brightness depending on the distribution 300 of the brightness values 110 of the pixels 105 of the image data 100.

The UE further comprises a camera 511. The camera 511 is configured to acquire the image data 110 comprising the pixels 105 which indicate the brightness values 110. It is possible that the image data 110 is at least temporarily stored in the memory 515. It is also possible that the image data 110 or further image data—the further image data being acquired by the camera 511 before or after the image data 110 is acquired by the camera 511—is displayed on a display of a HMI 512 of the UE 500. The HMI 512 can comprise further elements for interaction with a user, e.g., buttons, voice control, loadspeakers, a touch pad, etc.

Further, the UE 500 comprises the ambient light sensor 513. E.g., the ambient light sensor 513 may be situated on a top side of the UE 500 which is facing the user during normal operation. Likewise, it is possible that the camera 511 is located on a backside of the UE 500 which does not face the user during normal operation. In other words, it is possible that the directions of view of the camera 511 and the ambient light sensor 513 are substantially opposite to each other.

Further, the UE 500 comprises an interface 514 for communication with other entities. E.g., the interface 514 may be configured to operate according to such standards as universal serial bus (USB), wireless local area network (WLAN), and cellular access technologies according to the 3GPP standard.

In FIG. 6, a flowchart of a method according to various embodiments is shown. First, at S1, the image data 110 is received by the processor 510 of the UE 500. E.g., the processor 510 may receive the image data 110 directly from the camera 511 and/or from the memory 515.

Then, the processor 510 selects the display brightness depending on the distribution 300 of the brightness values 110 of the pixels 105 of the image data 100 at S2.

The processor 510 then optionally controls the display of the HMI 512 to display the image data 100 employing the selected display brightness (not shown in FIG. 6). Alternatively or additionally it is possible that further image data is displayed employing the selected display brightness; e.g., subsequently acquired image data may be displayed using the selected display brightness. This may allow a low latency in the displaying of acquired image data on the display while, at the same time, the computational steps to select the display brightness can be executed appropriately.

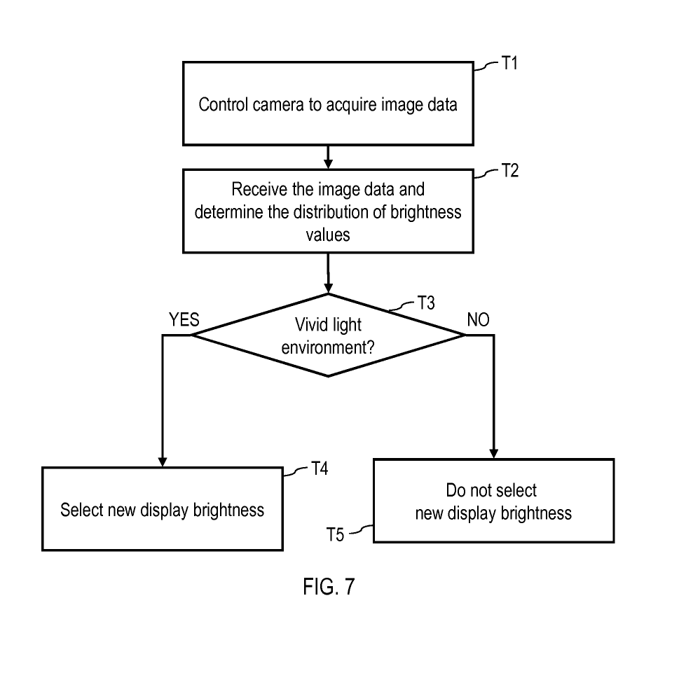

In FIG. 7, a scenario of a method according to a specific scenario is shown. Here, the display brightness is automatically boosted during photo recording and photo preview in a vivid light scenario. This is done by relying on the image data 100 acquired with the camera 511—instead of relying on the ambient brightness indicated by the control data received from the ambient light sensor 513; in this manner, better results may be achieved because typically the ambient light sensor 513—being positioned on a top side of the UE 500—is opposite to the vivid light spot and does not sense the ambient brightness in a field of view of the user and the camera 511; the ambient light sensor 513 is thus not able to detect the vivid light spot.

First, at T1 the processor 510 controls the camera 511 to acquire the image data 110. E.g., the processor 510—during photo acquisition preview—can control the camera 511 to continuously acquire image data 100.

Next, at T2, the processor 510 receives the image data 100 from the camera 511. The processor 510 then determines the distribution 300 of the brightness values 110. Said determining of the distribution 300 of the brightness values 110 can, e.g., correspond to determining the differences 310 of the average brightness values of the image regions 400 of the image data 100 (cf. FIG. 4).

At T3, the processor 510 decides whether a vivid light environment is present. For this purpose, it is possible to execute a threshold comparison with a predefined threshold; e.g., a characteristic width of the distribution 300 of the brightness values 110 can be compared to the predefined threshold; e.g., the characteristic width can correspond to a maximum width of the distribution 300, to a full width at half maximum of the distribution 300, and/or to any other specific property of the distribution 300. In one scenario, it is possible to compare the differences 310 of the average brightness values of the different image areas 400 of the image data 100 with the predefined difference threshold 410 (cf. FIG. 4). If any of the differences 310 exceed the predefined difference threshold 410, at T3 it is judged that the vivid light scenario is present; then, the method commences at T4. At T4, a new display brightness is selected. E.g., the new display brightness may be selected as the maximum display brightness at T4.

However, if, at T3, it is judged that the vivid light environment is not present, the method commences at T5. At T5, no new display brightness is selected. At T5, it is possible to reply upon a prior value selected for the display brightness; e.g., such a prior value may be determined based on the control data received from the ambient light sensor 513 indicating the ambient brightness.

Although the invention has been shown and described with respect to certain preferred embodiments, equivalents and modifications will occur to others skilled in the art upon the reading and understanding of the specification. The present invention includes all such equivalents and modifications, and is limited only by the scope of the following claims.

1. A user equipment, comprising:
a camera,
at least one processor configured to receive image data from the camera, the image data comprising pixels and indicating brightness values for the pixels,
wherein the at least one processor is further configured to select a display brightness depending on a distribution of the brightness values of at least some of the pixels,
wherein the at least one processor is further configured to control a display of the user equipment to display at least one of the image data and further image data employing the selected display brightness.

2. The user equipment of claim 1,
wherein the distribution of the brightness values is specified by differences of the brightness values of pairs of the at least some of the pixels.

3. The user equipment of claim 1,
wherein the distribution of the brightness values is specified by differences of average brightness values of pairs of associated image regions of the image data, the average brightness values being averages over the brightness values of pixels situated in the respective image region.

4. The user equipment of claim 3,
wherein the at least one processor is configured to execute a threshold comparison between each one of the differences of the average brightness values and a predefined difference threshold,
wherein the at least one processor is configured to select the display brightness depending on the threshold comparison.

5. The user equipment of claim 1,
wherein the at least one processor is configured to select the display brightness depending on a characteristic width of the distribution of the brightness values.

6. The user equipment of claim 1,
wherein the at least one processor is configured to select a first display brightness if the distribution indicates a difference of the brightness values of the at least some of the pixels exceeding a predefined threshold,
wherein the at least one processor is configured to select a second display brightness if the distribution indicates the difference of the brightness values of the at least some of the pixels not exceeding the predefined threshold,
wherein the first display brightness is higher than the second display brightness.

7. The user equipment of claim 1,
the user equipment further comprising:
an ambient light sensor,
wherein the at least one processor is configured to receive control data from the ambient light sensor, the control data indicating an ambient brightness,
wherein the at least one processor is further configured to select a candidate display brightness based on the control data,
wherein the at least one processor is further configured to selectively select the candidate display brightness as the display brightness depending on the distribution of the brightness values of the at least some of the pixels.

8. The user equipment of claim 1,
the user equipment further comprising:
an ambient light sensor,
wherein the at least one processor is configured to receive control data from the ambient light sensor, the control data indicating an ambient brightness,
wherein the at least one processor is further configured to execute a threshold comparison between the ambient brightness and a predefined brightness threshold based on the control data,
wherein the at least one processor is configured to selectively execute said controlling of the display to display at least one of the image data and the further image data employing the selected display brightness depending on the threshold comparison.

9. The user equipment of claim 1,
wherein the at least one processor is configured to select the display brightness in a pixel-dependent manner.

10. The user equipment of claim 1,
wherein the user equipment is a mobile device of a group comprising a mobile phone, a smartphone, a personal digital assistant, a mobile music player, a smart watch, a wearable electronic equipment, a camera, an event data recorder, and a mobile computer.

11. A method, comprising the steps:
at least one processor receiving image data from a camera of a user equipment, the image data comprising pixels and indicating brightness values for the pixels,
depending on a distribution of the brightness values of at least some of the pixels, the at least one processor selecting a display brightness,
the at least one processor controlling a display of the user equipment to display at least one of the image data and further image data employing the selected display brightness.

12. The method of claim 11,
wherein the distribution of the brightness values is specified by differences of the brightness values of pairs of the at least some of the pixels.

13. The method of claim 11,
wherein the distribution of the brightness values is specified by differences of average brightness values of pairs of associated image regions of the image data, the average brightness values being averages over the brightness values of pixels situated in the respective image region.

14. The method of claim 13, further comprising the step:
the at least one processor executing a threshold comparison between each one of the differences of the average brightness values and a predefined difference threshold,
wherein said selecting of the display brightness depends on the threshold comparison.

15. The method of claim 11,
wherein said selecting of the display brightness depends on a characteristic width of the distribution of the brightness values.

16. The method of claim 11,
wherein said selecting of the display brightness comprises:
selecting a first display brightness if the distribution indicates a difference of the brightness values of the at least some of the pixels exceeding a predefined threshold,
selecting a second display brightness if the distribution indicates a difference of the brightness values of the at least some of the pixels not exceeding the predefined threshold,
wherein the first display brightness is higher than the second display brightness.

17. The method of claim 11,
wherein said selecting of the display brightness comprises:
the at least one processor receiving control data from an ambient light sensor of the user equipment, the control data indicating an ambient brightness,
based on the control data, the at least one processor selecting a candidate display brightness,
depending on the distribution of the brightness values of the at least some of the pixels, the at least one processor selectively selecting the candidate display brightness as the display brightness.

18. The method of claim 17,
wherein said selecting of the display brightness comprises:
depending on the distribution of the brightness values of the at least some of the pixels, the at least one processor selectively selecting a maximum display brightness as the display brightness.

19. The method of claim 11, further comprising the steps:
the at least one processor receiving control data from an ambient light sensor of the user equipment, the control data indicating an ambient brightness,
based on the control data, the at least one processor executing a threshold comparison between the ambient brightness and a predefined brightness threshold,
wherein said controlling of the display to display at least one of the image data and the further image data employing the selected display brightness is selectively executed depending on the threshold comparison.

20. The method of claim 11,
wherein said selecting of the display brightness occurs in a pixel-dependent manner.
